(19) United States
(12) Patent Application Publication
(10) Pub. No.: US 2003/0217630 A1
(43) Pub. Date: Nov. 27, 2003

(54) Bar cutting assembly

(75) Inventors: James P. Flanagan, Lilburn, GA (US); Martin Humphreys, Spring Hill, FL (US); Lawrence Smith, Orion, MI (US)

Correspondence Address: MICHAEL BEST & FRIEDRICH LLP, 3773 CORPORATE PARKWAY, SUITE 360, CENTER VALLEY, PA, 18034-8217, US

(73) Assignee: Timken U.S. Corporation, Torrington, CT

(21) Appl. No.: 10/391,352

(22) Filed: Mar. 18, 2003

(30) Foreign Application Priority Data
Aug. 1, 2002 (WO) PCT/US02/24322

(51) Int. Cl. B26D 1/00

(52) U.S. Cl. 83/651

(57) ABSTRACT

A bar cutting assembly including a mounting assembly having a through hole and mounted for rotational movement. A cutter assembly is mounted on the mounting assembly such that the cutting tool rotates in conjunction with the mounting assembly. The cutter assembly is configured to progressively move axially relative to the mounting assembly upon each rotation such that the cutting assembly moves progressively across at least a portion of the through hole.

This application claims the benefit of PCT Application No. PCT/US02/24322 filed on Aug. 1, 2002.

### BACKGROUND

The present invention relates to bar and tube cutting assemblies. More particularly, the present invention relates to a cutting assembly configured to continuously cut non-rotating bars and tubes.

### SUMMARY

The present invention provides to a bar cutting assembly including a mounting assembly having a through hole and mounted for rotational movement. A drive is associated with the mounting assembly to provide controlled rotation of the mounting assembly. A cutter assembly is mounted on the mounting assembly such that the cutting tool rotates in conjunction with the mounting assembly. The cutter assembly is configured to progressively move axially relative to the mounting assembly upon each rotation such that the cutter assembly moves progressively across at least a portion of the through hole.

In a preferred embodiment of the invention, the bar cutting assembly further includes a cam plate mounted for co-axial rotation with the mounting assembly. The cam plate includes a cam track having an track axis off set from a central axis of the cam plate. A cam follower extends from the cutter assembly and is configured to engage and follow the cam track. As the mounting assembly and cam plate rotate at off set speeds relative to one another, the cam follower causes the cutter assembly to move progressively across at least a portion of the through hole. Preferably, a first drive is associated with the mounting assembly and a second drive is associated with the cam plate. The first and second drives are configured to rotate the mounting assembly and cam plate at different speeds to create the off set rotation.

### BRIEF DESCRIPTION OF THE DRAWINGS

FIG. 1 is a front elevation of a bar cutting assembly that is a first embodiment of the present invention;

FIG. 2 is a cross sectional view taken along line 2-2 of FIG. 1.

FIG. 3 is a cross sectional view of a cutting assembly in accordance with the first embodiment of the present invention.

FIG. 4 is an isometric view, in partial section, of the cutting assembly of FIG. 3 mounted in a housing.

FIG. 5 is an elvational view of a base plate of the present invention.

FIG. 6 is an isometric view of a spindle of the cutting assembly of FIG. 3.

FIG. 7 is an isometric view of the cutter assembly of the cutting assembly of FIG. 3.

FIGS. 8 and 9 are isometric views of preferred cutting tools of the present invention.

FIG. 10 is an isometric view of the counter weight assembly and base plate of the cutting assembly of FIG. 3.

FIG. 11 is a front elevational view of the cam plate of the cutting assembly of FIG. 3.

FIG. 12 is a front elevational view of an illustrative pulley plate.

FIGS. 13-15 are schematic views of the cam plate and cutting assembly illustrating the operating sequence of the preferred embodiment of the present invention.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

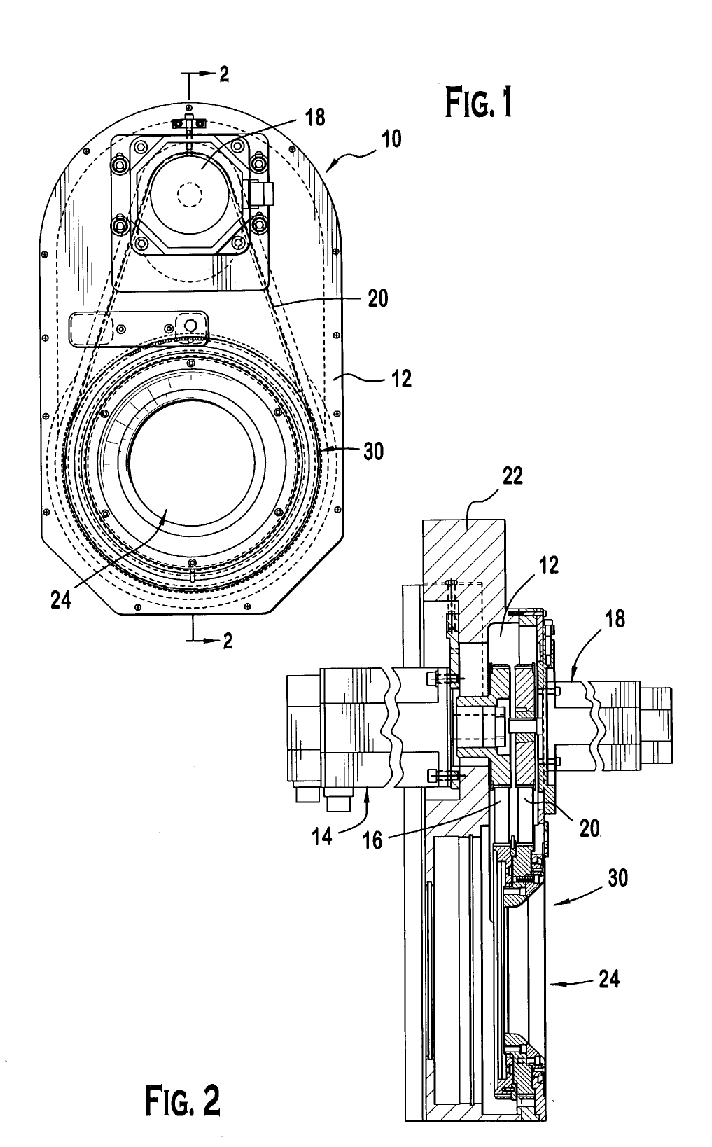

Referring to FIGS. 1 and 2, a bar cutting assembly 10 that is a preferred embodiment of the present invention is shown. The bar cutting assembly 10 includes a housing 12 with a cutting assembly 30 mounted therein. A bar or tube (not shown) to be cut is extended through a through hole 24 in the cutting assembly 30 and is fixed in position via a support assembly (not shown). A vertical ball screw 22 or the like is preferably provided to allow vertical adjustment of the cutting assembly 30 relative to the bar or tube. First and second drives 14, 18 and associated pulley links 16, 20 are provided to control the cutting assembly 30 as will be described hereinafter. Various drives, for example, servo motors, engines or other drive structures may be utilized. Suitable drives are Alpha 30 servo motors available from GE Fanuc Automation, Charlottesville, Va. The drives are preferably controlled by a programmable microprocessor, for example, a Series 18 Model C CNC control available from GE Fanuc Automation, Charlottesville, Va.

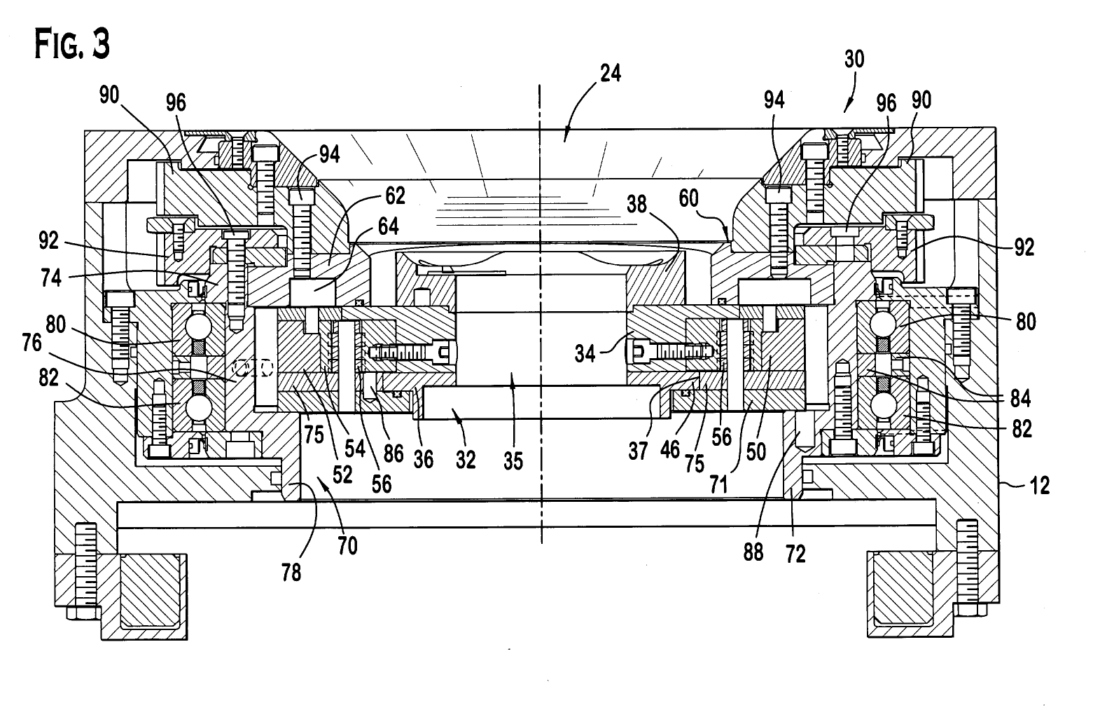

Referring to FIGS. 3 and 4, a preferred embodiment of the cutting assembly 30 will be described. The cutting assembly 30 generally comprises a mounting assembly 70 configured for rotatably mounting a cutter assembly 32 within the housing 12. A counter weight assembly 50 is preferably associated with the cutter assembly 32 to maintain balance of the cutting assembly 30. A cam assembly 60 is supported within mounting assembly 70 for co-axial rotation therewith.

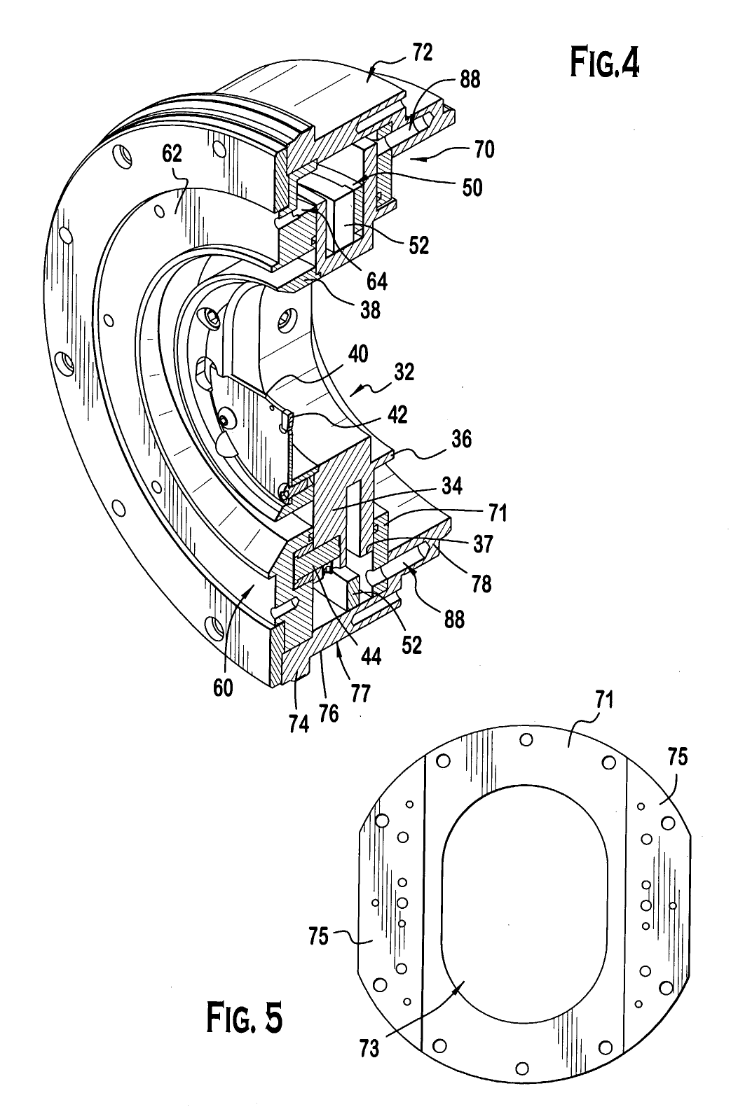

The preferred mounting assembly 70 includes a spindle 72 connected to a base plate 71 at one or more connection points 88. Referring to FIG. 5, the base plate 71 has an aperture 73 therethrough. The aperture 73 has guide plates 75 adjacent thereto for guiding axial motion of the cutter assembly 32 as will be described hereinafter. Referring to FIGS. 3, 4 and 6, the preferred spindle 72 includes a lower portion 78 configured to extend inward for connection to the base plate 71. The base plate 71 may be formed integral with the lower portion 78 such that the spindle 72 has the desired contact and support configuration. A middle portion 76 extends from the lower portion 78 and has an outer bearing surface 77 configured to contact and rotate about upper and lower bearings 80 and 82 mounted within the housing. Spacer rings 84 are preferably positioned between the upper and lower bearings 80 and 82. An upper portion 74 of the spindle 72 contains an end of the upper bearing 80 and defines a radial support for the cam plate 62, as will be described hereinafter. Other support members, bearings and seals (unnumbered in FIG. 3) may be provided to properly position and support the bearings 80, 82 in the housing 12. While roller bearings are illustrated, other bearing arrangements, for example, lubricated bearing surfaces may also be utilized.

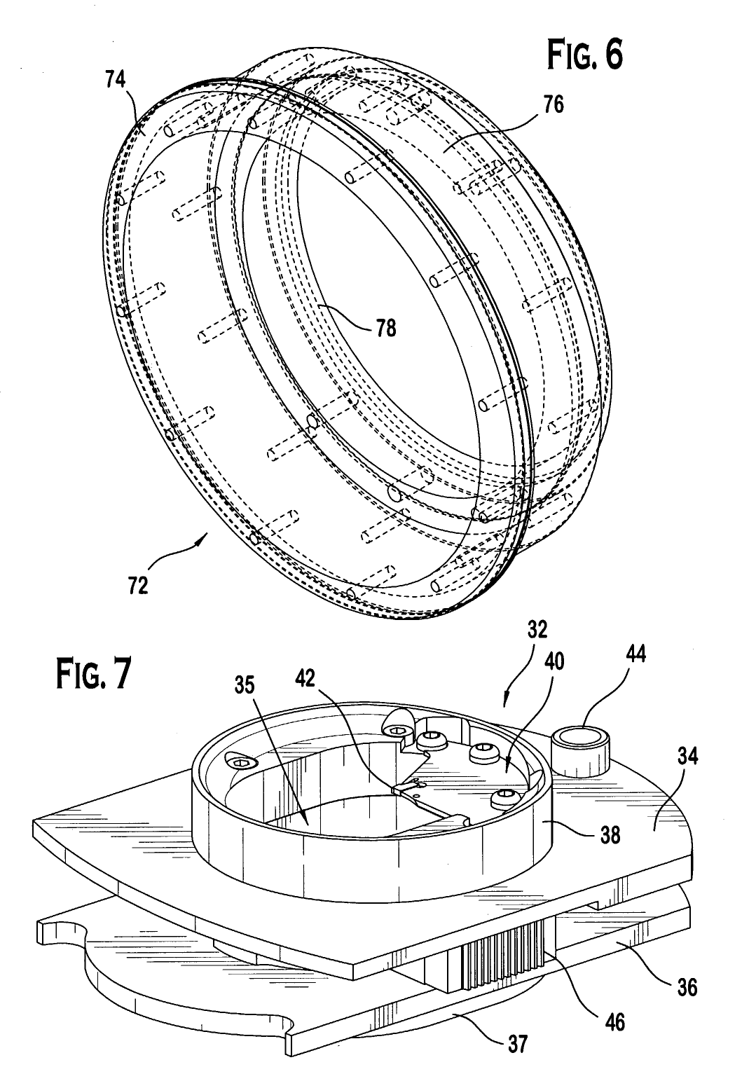

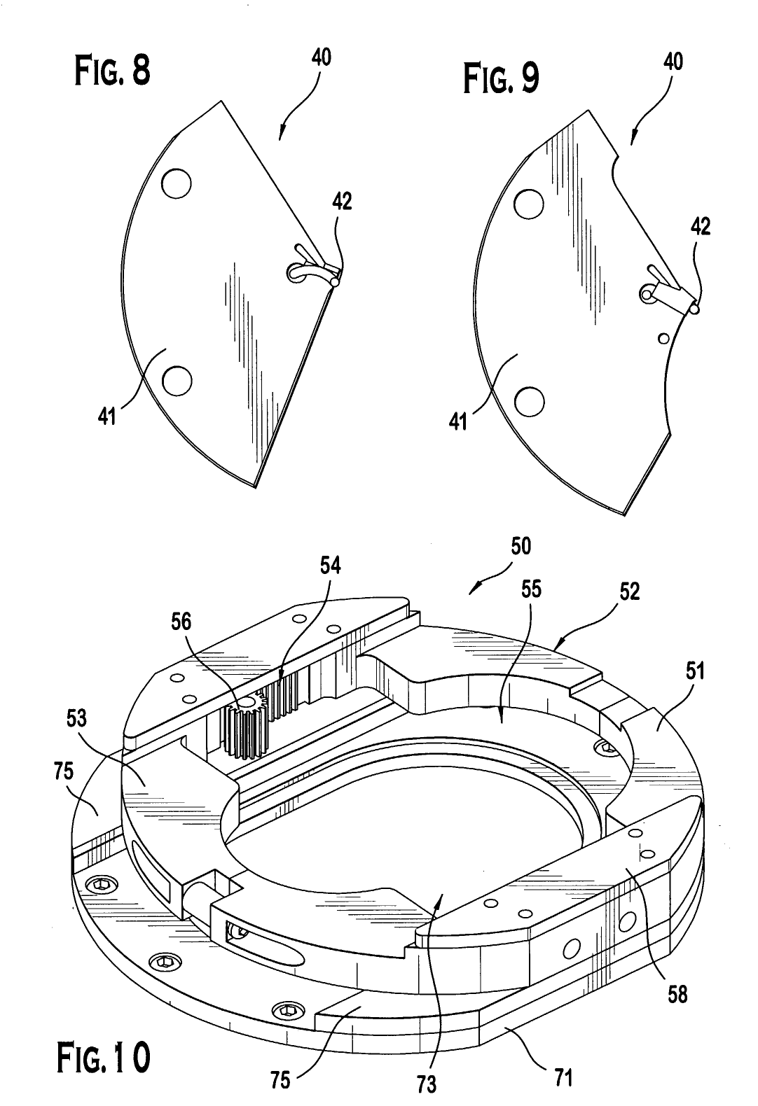

The preferred cutter assembly 32 will be described with reference to FIGS. 3, 4 and 7. The cutter assembly 32 includes interconnected upper and lower slide plates 34, 36 with an aperture 35 therethrough. The plates 34, 36 are preferably manufactured as separate plates, but may be formed as a unitary structure. The lower plate 36 includes a straight edge 37 configured to fit in and guide axial movement along the base plate guide plates 75. A tool holder 38 extends from the upper plate 34 and is configured to support a cutting tool 40. Illustrative cutting tools 40 are shown in FIGS. 8 and 9. Each cutting tool 40 has a support body 41 and a cutting tip 42 connected thereto. A preferred method of supporting the cutting tip 42 includes a patented designed pocket in the name of Sandvik Coromant Company of Fair Lawn, N.J. As can be seen, the tool body 41 can have a varying configuration to accommodate bars or tubes of different sizes. Additionally, the cutting tip 42 can have different configurations to accommodate bars of different materials and the like. The body 41 is preferably configured to hold different tips 42 to allow easy changing of the cutting arrangement, or alternatively, the entire cutting tool 40 can be easily removed and replaced. Also extending from the upper plate is a cam follower 44 that will be described in further detail hereinafter. A serrated rack 46 extends from each side of the slide plates 34, 36 for engagement with a pinion 56 (see FIGS. 3 and 10) to drive a counterweight assembly 50.

Referring to FIGS. 3 and 10, the preferred counterweight assembly 50 includes a body 52 having a lighter end 51 and a heavier end 53. The weight difference is preferably provided by varying the thickness of the body 52. The body 52 may be manufactured as a unitary structure or as multiple components, as illustrated in FIG. 10. The counterweight body 52 is configured for guided axial movement along the edge of slide plate 34. The counterweight assembly 50 includes opposed racks 54 configured to engage the pinions 56 such that the counterweight body 52 moves with the cutter assembly 32 to maintain a balanced cutting operation. The counterweight body 52 may be made from varying materials, with a preferred material being tungsten.

Referring to FIGS. 3, 4 and 11, the preferred cam assembly 60 will be described. The cam assembly 60 includes a cam plate 62 with a cam track 64 defined there along. The cam track 64 is preferably formed by a groove in the plate 62, but may be manufactured from other structures, for example, an extending rail. The cam track 64 is off set from the outer diameter 65 of the cam plate 62, that is, the cam track 64 has an axis TA that is off set from the cam plate axis CA, such that a follower traveling in the track 64 will move axially relative to the cam plate 62. The cam plate 62 may be provided with a cavity 66 to balance the cam plate 62.

Referring to FIGS. 3 and 4, the cam plate 62 is positioned within the spindle upper portion 74 adjacent the cutter assembly 32. The cam follower 44 extending from the upper slide plate 34 is received in the cam track 64 such that as the cam plate 62 rotates relative to the cutter assembly 32, the cam follower 44 travels along the cam track 64, thereby causing the cutter assembly 32 to move relative to mounting assembly 70, and thereby moving the cutting tool 40 across the through hole 24. As the cutter assembly 32 moves axially, the interaction between the racks 46, 54 and the pinion 56 cause the counterweight to move along with the cutter assembly 32.

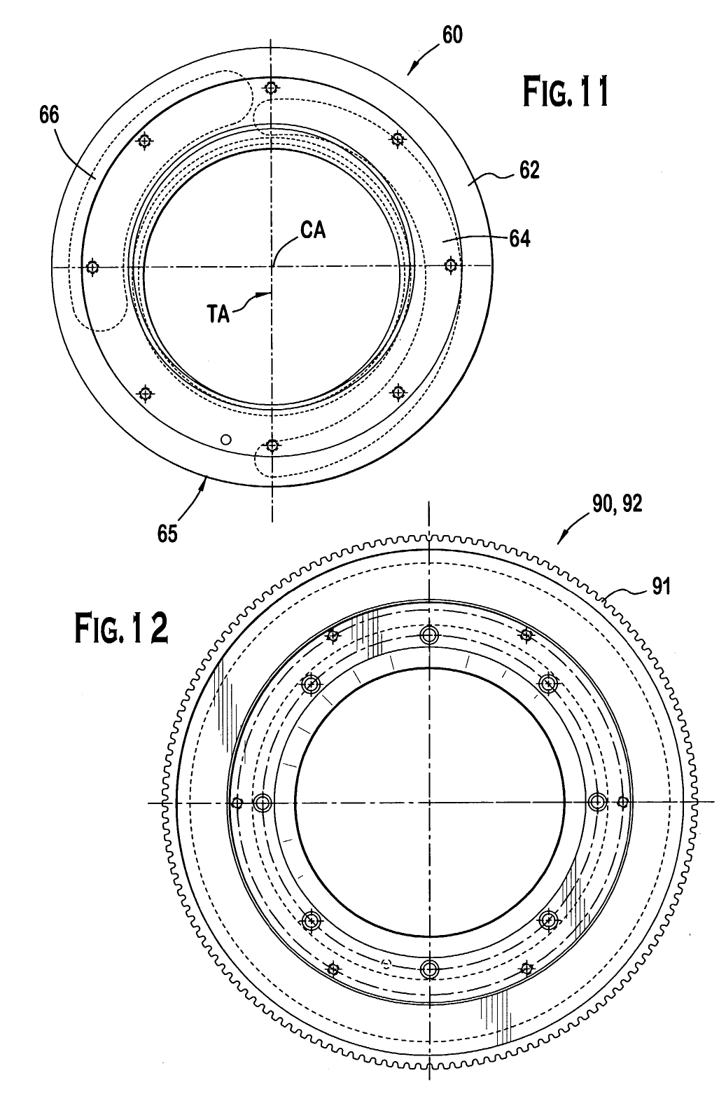

Relative motion between the cam plate 62 and the cutter assembly 32 is preferably accomplished utilizing the first and second drives 14, 18 and associated pulley links 16, 20. As can be seen in FIG. 3, the cam plate 62 is directly associated with a pulley plate 90 via fasteners or other engagement means 94. The pulley plate 90 is driven via the pulley link 20 by the second drive 18. A second pulley plate 92 is associated with the spindle 72 via fasteners or other engagement means 96. An illustrative pulley plate 90, 92 is shown in FIG. 12. The pulley plates 90, 92 preferably include a toothed edge 91, but may include other engagement means, for example, a friction surface. Additionally, the plates 90, 92 may be of the same or different sizes and configurations.

The spindle 72 is in turn connected to the base plate 71 which engages the slide plates 35, 36. As such, rotation of second pulley plate 92 rotates the spindle 72 and base plate 71 which causes rotation of the cutter assembly 32 therewith. The pulley plate 92 is driven via the pulley link 16 by the first drive 14. Since the cutter assembly 32 and cam plate 64 are independently driven, they can be rotated at different speeds to create a rotation off set. The rotation off set causes the cam follower 44 to travel along the cam track 64, thereby causing the cutter assembly 32 to move axially in direct correlation with rotation of the cam plate 62 and the cutter assembly 32. While the preferred embodiment utilizes two independent drives to accomplish the rotation off set, other means, for example, fixed or variable gear means, may also be utilized to accomplish such.

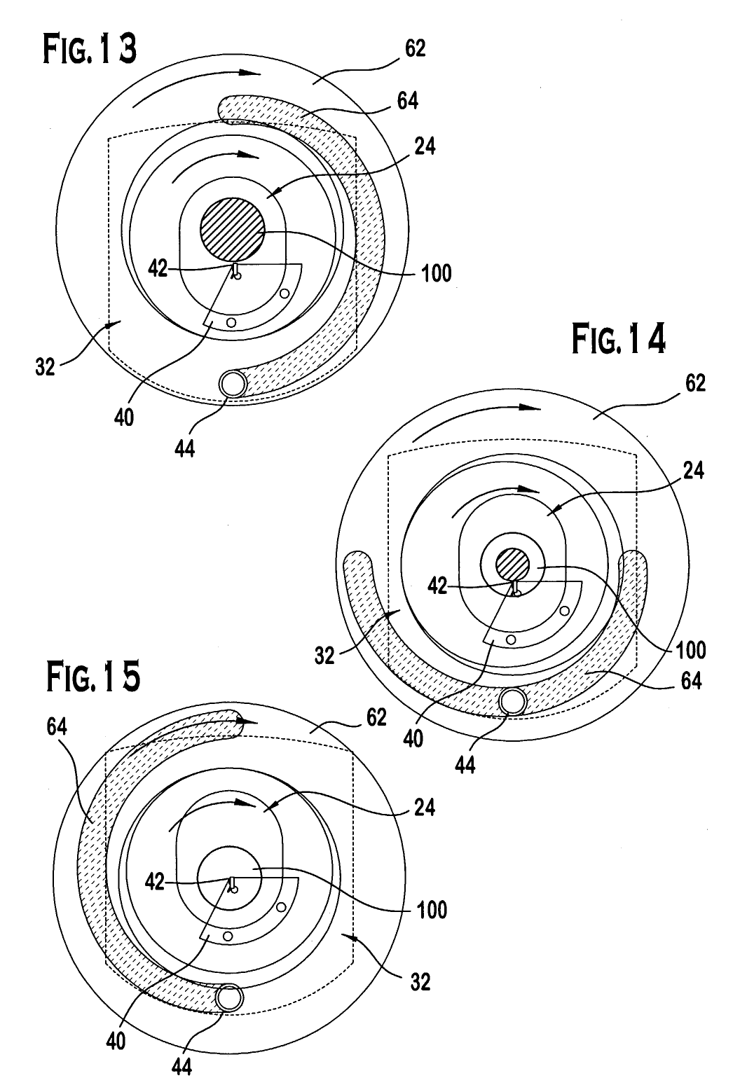

Having described the components of the preferred cutting assembly 10, its operation will be described with reference to FIGS. 13-15. Referring to FIG. 13, a bar or tube 100 is fixed within the through hole 24. The cutter assembly 32 and the cam plate 62 are in an initial position with the cam follower 44 in an end portion of the cam track 64 furthest from through hole 24 axis. The first and second drives 14, 18 rotate the cutter assembly 32 and cam plate 62 such that the cutter tip 42 continuously cuts around the circumference of the bar or tube 100. To continuously feed the cutter tip 42 inward, the drives 14, 18 rotate the cutter assembly 32 and the cam plate 62 at different rates. As such, the cam follower 44 moves along the cam track 64 to move the cutting tool 40 inward as illustrated in FIGS. 14 and 15. In the preferred embodiment, the cam track 64 is configured such that a 180° off set between the cutter assembly 32 and cam plate 62, see FIG. 15, causes the cutter tip 42 to move to the center of the cutting area to completely cut the bar or tube 100. To avoid damaging of the tip 42, the off set between the cutter assembly 32 and the cam plate 62 is accomplished over numerous rotations. For example, if the bar or tube 100 is 2 inches in diameter, by moving the cutting tip 42 0.002 inches per revolution, the cutter assembly 42 must be rotated 500 revolutions to cut through a solid bar 100 (i.e. the cutter tip 42 traveling the bar radius of 1 inch). With the cutter assembly 42 rotating 500 revolutions, the cam plate must rotate 500.5 revolutions. As such, the controller will drive the second drive 18 slightly faster than the first drive 14, creating the desired revolution off set. For example, the first drive 14 may be rotated at 1000 rpm while the second drive is rotated 1001 rpm. After the bar or tube 100 is cut, the cutter assembly 32 and cam plate 62 are returned to the initial position. This is preferably accomplished by rotating the cam plate 62 1.5 revolutions while cutter assembly 32 is rotated 2 revolutions. For example, after the final cut, the second drive 18 speed may be reduced to 750 rpm with the first drive maintaining a 1000 rpm speed.

The above example is given for illustration purposes only. Other bar or tube sizes may be cut. Additionally, the feed rate does not have to be 0.002 inches per revolution, but may be any desired rate. Based on the desired feed rate, the necessary cutting distance, and desired cutting time, the controller can be configured to drive the two drives 14, 18 at the necessary relative off set speeds.

What is claimed is:

1. A bar cutting assembly comprising:
a mounting assembly having a through hole and mounted for rotational movement;
a first drive associated with the mounting assembly for controlled rotation of the mounting assembly; and
a cutter assembly engaged by the mounting assembly such that the cutting tool rotates in conjunction with the mounting assembly, the cutter assembly configured to progressively move axially relative to the mounting assembly upon each rotation such that the cutter assembly moves progressively across at least a portion of the through hole.

2. The bar cutting assembly of claim 1 wherein the cutter assembly includes a replaceable cutting tool with a cutting tip extending toward the through hole.

3. The bar cutting assembly of claim 1 wherein the cutter assembly includes a slide plate assembly configured to hold a cutting tool with a cutting tip, the slide plate having a portion configured to engage and slide axially along a portion of the mounting assembly.

4. The bar cutting assembly of claim 3 further comprising a counterweight having first and second portions of different weights, the counterweight supported adjacent to the slide plate for relative movement therewith.

5. The bar cutting assembly of claim 4 wherein a rack and pinion assembly extends between the slide plate and the counterweight such that axial movement slide plate causes proportional axial movement of the counterweight.

6. The bar cutting assembly of claim 1 wherein the mounting assembly includes a spindle supported by a bearing assembly positioned in a housing.

7. The bar cutting assembly of claim 6 wherein the mounting assembly further includes a base member associated with the spindle, the base member including opposed guide plates configured to contact a portion of the cutter assembly to engage the cutter assembly and create rotational movement thereof and to guide axial movement of the cutter assembly.

8. The bar cutting assembly of claim 1 further comprising a cam plate mounted for co-axial rotation with the mounting assembly, the cam plate including a cam track having an track axis off set from a central axis of the cam plate and a cam follower extending from the cutter assembly and configured to engage and follow the cam track such that as the mounting assembly and cam plate rotate at off set speeds relative to one another, the cutter assembly moves progressively across at least a portion of the through hole.

9. The bar cutting assembly of claim 8 wherein the cam track is a groove in the cam plate.

10. The bar cutting assembly of claim 9 wherein the groove is a 180° semi-circle with a first end furthest from the cam plate central axis and a second end closest to the cam plate central axis.

11. The bar cutting assembly of claim 10 wherein when the cam follower is at the cam track first end, a cutting tip of the cutter assembly is furthest from a central axis of the through hole and when the cam follower travels to the second track end, the cutting tip is adjacent to the through hole central axis.

12. The bar cutting assembly of claim 8 wherein the mounting assembly is driven by the first drive and the cam plate is driven by a second drive.

13. The bar cutting assembly of claim 12 wherein the first and second drives are controlled by programmable control configured to drive the first and second drives such that the mounting assembly and cam plate rotate at different speeds.

14. The bar cutting assembly of claim 12 wherein the first and second drives are servo motors.

15. The bar cutting assembly of claim 8 wherein the mounting assembly is associated with a first gear and the cam plate is associated with a second gear, the first and second gears having a desired gear ratio, such that simultaneous rotation of the gears by the first drive creates a desired off set rotation between the mounting assembly and the cam plate.

16. A bar cutting assembly comprising:
a mounting assembly having a through hole and mounted for rotational movement;
a cutter assembly mounted for axial movement along the mounting assembly;
a cam plate mounted for co-axial rotation with the mounting assembly, the cam plate including a cam track having an track axis off set from a central axis of the cam plate; and
a cam follower extending from the cutter assembly and configured to engage and follow the cam track such that as the mounting assembly and cam plate rotate at off set speeds relative to one another, the cutter assembly moves progressively across at least a portion of the through hole.

17. The bar cutting assembly of claim 16 wherein the cutter assembly includes a replaceable cutting tool with a cutting tip extending toward the through hole.

18. The bar cutting assembly of claim 16 wherein the cutter assembly includes a slide plate assembly configured to hold a cutting tool with a cutting tip, the slide plate having a portion configured to engage and slide axially along a portion of the mounting assembly.

19. The bar cutting assembly of claim 18 further comprising a counterweight having first and second portions of different weights, the counterweight supported adjacent to the slide plate for relative movement therewith.

20. The bar cutting assembly of claim 19 wherein a rack and pinion assembly extends between the slide plate and the counterweight such that axial movement slide plate causes proportional axial movement of the counterweight.

21. The bar cutting assembly of claim 16 wherein the mounting assembly includes a spindle supported by a bearing assembly positioned in a housing.

22. The bar cutting assembly of claim 21 wherein the mounting assembly further includes a base member associated with the spindle, the base member including opposed guide plates configured to contact a portion of the cutter assembly to engage the cutter assembly and create rotational movement thereof and to guide axial movement of the cutter assembly.

23. The bar cutting assembly of claim 16 wherein the cam track is a groove in the cam plate.

24. The bar cutting assembly of claim 23 wherein the groove is a 180° semi-circle with a first end furthest from the cam plate central axis and a second end closest to the cam plate central axis.

25. The bar cutting assembly of claim 24 wherein when the cam follower is at the cam track first end, a cutting tip of the cutter assembly is furthest from a central axis of the through hole and when the cam follower travels to the second track end, the cutting tip is adjacent to the through hole central axis.

26. The bar cutting assembly of claim 16 wherein the mounting assembly is driven by a first drive and the cam plate is driven by a second drive.

27. The bar cutting assembly of claim 26 wherein the first and second drives are controlled by programmable control configured to drive the first and second drives such that the mounting assembly and cam plate rotate at different speeds.

28. The bar cutting assembly of claim 26 wherein the first and second drives are servo motors.

29. The bar cutting assembly of claim 16 wherein the mounting assembly is associated with a first gear and the cam plate is associated with a second gear, the first and second gears having a desired gear ratio, such that simultaneous rotation of the gears creates a desired off set rotation between the mounting assembly and the cam plate.

30. A bar cutting assembly comprising:
a mounting assembly having a through hole and mounted for rotational movement;
a cutter assembly mounted for axial movement along the mounting assembly;
a cam plate mounted for co-axial rotation with the mounting assembly, the cam plate including a cam track having a track axis off set from a central axis of the cam plate;
a cam follower extending from the cutter assembly and configured to engage and follow the cam track; and
a first drive associated with the mounting assembly and a second drive associated with the cam plate, the first and second drives configured to rotate the mounting assembly and cam plate at different speeds to create an off set rotation that causes the cutter assembly to move progressively across at least a portion of the through hole.

31. The bar cutting assembly of claim 30 wherein the first and second drives are controlled by programmable control configured to drive the first and second drives such that the mounting assembly and cam plate rotate at different speeds.

32. The bar cutting assembly of claim 30 wherein the first and second drives are servo motors.

33. The bar cutting assembly of claim 30 wherein the cutter assembly includes a replaceable cutting tool with a cutting tip extending toward the through hole.

34. The bar cutting assembly of claim 30 wherein the cutter assembly includes a slide plate assembly configured to hold a cutting tool with a cutting tip, the slide plate having a portion configured to engage and slide axially along a portion of the mounting assembly.

35. The bar cutting assembly of claim 34 further comprising a counterweight having first and second portions of different weights, the counterweight supported adjacent to the slide plate for relative movement therewith.

36. The bar cutting assembly of claim 35 wherein a rack and pinion assembly extends between the slide plate and the counterweight such that axial movement slide plate causes proportional axial movement of the counterweight.

37. The bar cutting assembly of claim 30 wherein the mounting assembly includes a spindle supported by a bearing assembly positioned in a housing.

38. The bar cutting assembly of claim 37 wherein the mounting assembly further includes a base member associated with the spindle, the base member including opposed guide plates configured to contact a portion of the cutter assembly to engage the cutter assembly and create rotational movement thereof and to guide axial movement of the cutter assembly.

39. The bar cutting assembly of claim 30 wherein the cam track is a groove in the cam plate.

40. The bar cutting assembly of claim 39 wherein the groove is a 180° semi-circle with a first end furthest from the cam plate central axis and a second end closest to the cam plate central axis.

41. The bar cutting assembly of claim 40 wherein when the cam follower is at the cam track first end, a cutting tip of the cutter assembly is furthest from a central axis of the through hole and when the cam follower travels to the second track end, the cutting tip is adjacent to the through hole central axis.
